(19) United States
(12) Patent Application Publication
(10) Pub. No.: US 2023/0287532 A1
(43) Pub. Date: Sep. 14, 2023

(54) WORKPIECE HOLDING DEVICE

(71) Applicant: AKTIEBOLAGET SKF, Goteborg (SE)

(72) Inventors: Gerhard WAGNER, Prichsenstadt (DE); Fred MENIG, Sulzthal (DE); Martina STICHT, Sennfeld (DE); Michael WENDEL, Bremen (DE)

(21) Appl. No.: 18/117,600

(22) Filed: Mar. 6, 2023

(30) Foreign Application Priority Data
Mar. 11, 2022 (DE) 102022202465.6

(51) Int. Cl. C21D 9/00; C21D 11/00

(52) U.S. Cl. CPC C21D 9/0025; C21D 11/00; C21D 9/0037; C21D 1/18

(57) ABSTRACT

A workpiece holding device for holding a workpiece in a heat treatment system while the workpiece undergoes a thermal expansion and/or contraction includes at least two clamping units configured to apply a radial and/or an axial clamping force to the workpiece to hold the workpiece in the workpiece holding device in a predefined position, and an adjustment mechanism for setting the at least two clamping units to synchronously apply a substantially identical radial and/or axial clamping force to the workpiece.

### CROSS-REFERENCE

This application claims priority to German patent application no. 10 2022 202 465.6 filed on Mar. 11, 2022, the contents of which are fully incorporated herein by reference.

### TECHNOLOGICAL FIELD

The present disclosure is directed to a workpiece holding device for holding a workpiece in a heat-treatment system, wherein the workpiece experiences a thermal expansion and/or contraction due to a heat treatment or an expansion and/or contraction due to a density difference arising in the microstructure during the phase transformation.

### BACKGROUND

In order to thermally treat workpieces, for example to heat or quench them, the workpieces must be arranged securely and in a precise position relative to the treatment system in order to achieve very accurate heat input and subsequently defined quenching processes of the treatment zones. For this purpose conventional clamping means can be used, such as, for example, so-called three- or four-jaw chucks that include three or four clamping jaws that are mounted on a work table and grouped circumferentially around the tool to be held. The workpiece is clamped and held in these clamping jaws prior to treatment of the workpiece, wherein a repositioning of the clamping jaws is possible in order to compensate for a thermal contraction and/or expansion, or a contraction and/or expansion due to a density difference arising in the microstructure during the phase transformation. Furthermore, it is known with such devices to move the entire work table, together with the clamping jaws, past fixed heat sources in order to simplify the repositioning of the supply lines needed for the heat sources.

A disadvantage of this device, however, is that the force required for tracking the jaws due to the thermal expansion or contraction to be compensated for, or due to a density difference resulting from the phase transformation in the microstructure, may be too low and the jaws may then no longer be in contact with the workpiece and thus not be able to hold it sufficiently, or too high a force applied by the jaws may lead to deformation of the workpiece.

Furthermore, with known devices it is problematic that the large mass to be moved comprised of the work table, clamping jaws, and workpiece leads to very high wear in the drive system of the work table so that its components must often be replaced or the drive must be completely exchanged. Also, due to the large mass to be moved and the dimensions of the device, overall limits are set for the process parameters, such as for example, a relative speed between the inductor and the workpiece, with the result that an optimized heat input into the workpiece cannot always be achieved.

However, the heat input and the distribution of the heat input in the workpiece are of enormous importance in order to achieve the desired workpiece properties in the treatment zones and to control the resulting dimensional and shape changes (workpiece warpage). Known possibilities for influencing the heat input and the temperature distribution in the case of the example of an inductive hardening are a suitable choice of the process parameters or of the process design (electrical power, heating time, heating frequency, inductor-workpiece coupling distance, inductor material, inductor design, targeted use of magnetic field concentrators, workpiece material, previous condition of the workpiece material, relative speed of the workpiece with respect to the inductor, etc.)

### SUMMARY

The workpiece holding device is therefore a decisive element of the heat-treatment system and of the success of the heat treatment. It is therefore an aspect of the present disclosure to provide a workpiece holding device, in particular a workpiece clamping system, that fulfills the following functions, preferably holistically:
Ensure a predefined inductor-workpiece coupling distance;
Position the workpiece in a defined position;
Hold the workpiece in a defined position against the acting forces (e.g., magnetic fields) during the entire process time;
Ensure good reproducibility of the heat treatment;
Allow the heat treatment at all positions of the workpiece (inside, outside, side surfaces above and below);
Avoid crack formation.

In the following, a workpiece holding device is presented for holding a workpiece in a heat-treatment system, wherein the workpiece received in the workpiece holding device experiences a thermal expansion and/or contraction, or an expansion and/or contraction due to a density difference arising in the microstructure during the phase transformation. In the following, only thermal expansion or contraction is discussed, since even with a phase transformation a thermal component is usually present. Furthermore, the workpiece holding device includes at least two clamping units that are designed to apply a radial and/or axial clamping force to the workpiece so that the workpiece is positioned in the workpiece holding device in a predefined position. The workpiece is in particular a closed curve that is preferably rotationally symmetric, such as, for example, an element of a plain or rolling-element bearing, a bearing ring, a gear, a bolt, a sleeve, a disc, etc.

In order to apply a uniform-as-possible clamping force to the workpiece and to thereby avoid deformations from occurring due to nonuniform force, the workpiece holding device furthermore includes an adjusting device that is designed to synchronously set at least two clamping units in order to apply a predefined, essentially identical radial and/or axial clamping force onto the workpiece. In addition, the synchronous clamping of the clamping units eliminates the need to regulate the defined position of the workpiece. The synchronous clamping of the clamping units automatically results in an unambiguous position of the workpiece.

According to one preferred exemplary embodiment, a single adjusting device is provided here that is designed to set all clamping units. The single adjusting device that sets all clamping units ensures that a substantially identical force is exerted on the workpiece by all clamping units.

Alternatively, a plurality of adjusting devices can also be provided that, for example, each set subgroups of clamping units, e.g., clamping units disposed opposite each other. Of course, it is of course also possible to provide a separate adjusting device for each clamping unit that is then controlled accordingly in order to obtain the synchronous clamping of the clamping units. However, the adjusting device/s that set/s all, or subgroups of, clamping units make/s possible a simple and cost-effective possibility to achieve a synchronous clamping with essentially equal clamping force.

Here it is preferred in particular when the adjusting device is designed to mechanically couple the clamping units. For this purpose the adjusting device can preferably include a belt, a chain, and/or a gear that can be brought into engagement mechanically with corresponding coupling elements provided on the clamping units. By movement of the adjusting device, for example, of the belt or of the gear, all clamping units are then clamped simultaneously and with the same force.

Of course, other adjusting devices are also possible and encompassed by the scope of the invention, that enable synchronous clamping of the clamping units with substantially identical force. Thus, for example, each clamping unit can also be clamped individually, wherein, for example, a corresponding control device can ensure the synchronicity of the clamping. However, due to the mechanical coupling and the use of only a single adjusting device, a particularly simple, robust, and cost-effective system can be provided that makes possible a synchronous clamping with an essentially identical clamping force.

According to one preferred exemplary embodiment, the adjusting device is furthermore designed to displace the clamping units radially, tangentially, circumferentially and/or axially with the aid of the adjusting device. This is advantageous in particular with annular or rotationally symmetric workpieces. In addition or alternatively to the mechanical coupling mentioned above, the adjusting device can also include other movable elements. Among other things, the adjusting device can include, for example, an electric or hydraulic drive. In general, prior to the thermal treatment, the clamping units are moved toward the workpiece until it is fixedly held between the clamping units. In order to be able to compensate for manufacturing tolerances, one or more of the clamping units can be supported such that it is eccentrically displaceable. In another embodiment, clamping units that hold a workpiece radially can also follow the thermal expansion/contraction of the workpiece in the axial direction.

According to a further advantageous exemplary embodiment, the clamping units are movable both radially and tangentially, which is advantageous in particular with a substantially circular workpiece to be treated. Here it is advantageous in particular when the movable element is formed as an eccentrically supported element, since the eccentric support provides both a radial and a tangential movability of the element. Thus not only can thermal expansions/contractions, or an expansions/contractions due to a density difference arising in the microstructure during the phase transformation, be supported, but also manufacturing tolerances, such as, for example, a certain ovality (out of roundness) of the workpiece can be compensated for during the clamping. Such an adapting is advantageous in particular with workpieces with closed curves, such as, for example, elements of a plain or rolling-element bearing, bearing rings, gears, bolts, sleeves, discs, etc.

According to one preferred exemplary embodiment, the workpiece receptacle includes only three, at most four, clamping units. Although theoretically even more clamping units can also be provided, it has been shown in practice that a uniform clamping can already be set with only three clamping units. In addition, these clamping units can be easily and precisely coupled with the adjusting device in order to exert a synchronous and essentially identical clamping on the workpiece. In addition, a space-saving embodiment can thereby be provided so that even workpieces with a small size can be received and treated in the workpiece holding device.

As mentioned above, the clamping units of the workpiece holding device are designed to apply a synchronous clamping force onto the workpiece and thus ensure a secure and positionally accurate grip of the workpiece in the workpiece holding device. Here it is preferred in particular when the clamping units include at least one movable element, or are themselves formed as a movable element that is preloaded toward the workpiece such that the movement of the movable element follows the thermal expansion and/or contraction, or an expansion and/or contraction due to a density difference arising in the microstructure during the phase transformation.

With the aid of the movable elements, the workpiece can be clamped with a defined force and defined force application points. In addition, this makes it possible to follow a workpiece shrinkage or reduced workpiece growth due to the thermal expansion and/or contraction in the temperature range of the phase transformations ferrite/alpha-iron to austenite/gamma-iron (A1 temperature to A3 temperature, at about 700° C. to 1150° C. depending on the steel, microstructure state and heating rate) and/or due to the subsequent cooling. At the same time, however, due to the movable elements, a workpiece growth or the reduced workpiece shrinkage due to the volume increase during the quenching in the range of the phase transformation from austenite/gamma iron to martensite and/or bainite/pearlite/ferrite (depending on the solution state and steel, this temperature range of the martensite formation can typically fall at approximately 400° C. to 100° C.) can also be followed.

According to a further advantageous exemplary embodiment, the preloading of the movable element is effected by a mechanical preload element. Mechanical preload elements can be easily installed and do not require additional controlling, which overall makes the workpiece holding device easily operable and cost-effective.

Here the mechanical preload element can be at least one spring element that interacts with the movable element and preloads the movable element toward the workpiece. For example, the spring element can be a wire spring, a plate spring, coil spring, and/or leaf spring, but plastics can also be used, such as, for example, an elastomer.

Furthermore, it is possible that the mechanical preload of the movable element is formed by a friction device that makes possible a movement of the movable element only after exceeding of a certain friction value. Based on the pressure that an expanding/contracting workpiece exerts on the movable element during a thermal processing, a movement of the movable element may thereby only be effected after exceeding a certain threshold value.

Instead of a mechanical preload device, the preload of the movable element can also be effected by a device that is controllable by a controller. Here the preload can be effected, for example, by a hydraulically, pneumatically, or electrically operated element that follows the thermal expansion/contraction. For example, the movable element can be an oil- or gas-operated pressure damper.

According to a further preferred exemplary embodiment, the movable element includes at least one rotatable element abutting against the workpiece; the rotational axis of the rotatable element is preferably configured parallel to a rotational axis of the workpiece. It can thereby be ensured that during the synchronous clamping of the clamping units, the positional inaccuracies of the workpiece can be corrected without friction against the clamping units.

In order to reduce the wear of the workpiece holding device components, in particular due to high mass, and at the same time to optimize the heat input into the workpiece, at least one drive unit is provided that is designed to move, in particular to set in rotation, the workpiece received in the workpiece holding device. Since only the workpiece, but not the entire unit comprised of workpiece, work table, clamping units, and further equipment must be set into motion, but rather only the workpiece, even with large workpieces a large weight reduction can be achieved of the parts to be set in motion. This in turn also allows, in addition to the lower loading of the components, and thus also lower wear of the components of the drive system, a more precise setting of the process parameters, such as, for example, the relative speed and thus an improved heat input into the workpiece. Furthermore, less energy need be expended in order to set the workpiece in rotation than with the conventional systems so that a cost reduction is also thereby possible.

According to one advantageous exemplary embodiment, the at least one drive unit is designed to abut against the workpiece and is formed as a friction wheel or friction roller that interacts in a friction-fit manner with the workpiece in order to move it. A particularly simple and cost-effective drive can thus be provided for the workpiece.

It is advantageous in particular here when the friction force applied between drive unit and workpiece is defined by a contact force between drive unit and workpiece. It can thereby be ensured that even with thermal contraction or expansion, or a contraction or expansion due to a density difference arising in the microstructure during the phase transformation, an optimized drive of the workpiece is provided. Here it is advantageous in particular when a measuring device, for example, a pressure sensor, that determines the contact force is provided on the drive unit. An embodiment is also advantageous here in which, based on the measured contact force, a controller can control the contact force such that the contact force and thus the friction force is optimized. It can thereby be ensured that even with thermal expansion or contraction, or an expansion or contraction due to a density difference arising in the microstructure during the phase transformation, or with structural non-uniformities, such as, for example, an imbalance, the workpiece is nonetheless always driven with a constant force. Damage due to high force on the workpiece is also avoided.

Furthermore, it can also thereby be ensured that a slippage between workpiece and drive unit is minimized. In addition, due to the specific contact force, wear between workpiece and drive unit can also be minimized. The workpiece warpage can also thereby be minimized and/or plastic workpiece deformations can be avoided or minimized. In addition, the defined friction force allows a precise setting of the relative speed; in particular, it is possible to allow the workpiece to rotate with a defined speed.

Since, as mentioned above, the clamping units can each include at least one rotatable clamping element abutting against the workpiece, this rotatable clamping element can, however, be passively moved along in the same manner during movement of the workpiece and thus reduce a friction during the moving of the workpiece.

According to a further preferred exemplary embodiment, at least one of the clamping units can also be configured as a drive unit. Here it is preferred in particular when the rotatable clamping element described above is actively rotationally driven. In this case, the rotatable clamping element can be configured as a friction wheel or a friction roller that abuts against the workpiece. It is also possible that the rotatable clamping element includes a friction surfacing or a friction coating that provides the active drive.

According to a further preferred exemplary embodiment, a controller is furthermore provided that controls a contact force and/or clamping force and/or friction force. Thus the controller can control, for example, the clamping force of the clamping unit, wherein preferably the controller is designed to control the movement of the movable element. Furthermore, for example, the clamping unit can include at least one measuring device for the recording of shape and dimensional changes during the heating process and after the conclusion of the heating process (warpage). The data recorded can also be used for subsequent processing procedures in order to undertake individual-workpiece adaptations to the processes.

In one preferred exemplary embodiment, at least one clamping unit, in particular the movable element, includes at least one force-measuring device that interacts with the controller and is configured to measure the contact force with which the clamping unit, in particular the movable element, abuts against the workpiece. Furthermore, the force measuring device can also measure a contact force and/or friction force of the clamping unit on the workpiece. The force measuring device preferably interacts with the controller.

In addition, the controller can also control a preload of the clamping units. A particularly precise following of the contraction/expansion is possible specifically with a preloading controlled with a controller. In order to further increase the accuracy and sensitivity of the following or tracking, the clamping unit, the support unit, and/or the drive unit can be equipped with at least one force measuring device that interacts with the controller and is designed to measure the contact force, clamping force, and/or friction force. Depending on this measured force, the controller can then control the clamping unit, the support unit, and/or the drive unit in order to exert a uniform force on the workpiece during the treatment. In addition, due to the force measuring device, an adapting to manufacturing inaccuracies is possible during the clamping of the workpiece into the workpiece holding device so that a uniform pressure on the various clamping units is already achieved during the clamping of the workpiece.

Alternatively or additionally, of course, the controller can also control the clamping unit, the support unit, and/or the drive unit based on a pre-calculated value table in order to be able to balance the calculated and anticipated expansions/contractions. Here the value table can be determined empirically and/or stored in a database that is accessible to the controller. This means the database can be stored internally in the controller itself or available in an external database.

In one preferred design, the controller can also additionally react to forces that act on the workpiece due to the processing system and increase or decrease a preload in a manner depending on measured forces or proactively. For example, in expectation of electrical, mechanical or magnetic forces that temporarily act on the workpiece, the current preload can be increased or decreased by a preload value in a targeted controlled manner. This temporary superposition of the preload regulated due to the thermal expansion and/or contraction, or expansion and/or contraction due to a density difference arising in the microstructure during the phase transformation, with a controlled offset can preferably be switched on and off. Here also, the clamping unit, support unit, and/or drive unit can be controlled based on a value table in order to be able to reliably support and/or balance the calculated and expected forces on the workpiece. Furthermore, the controller can be designed such that it can be switched from a regulated operation, in which the preload forces are set based on measured values of the force measuring device, e.g., a load cell, to a controlled operation in which the preload forces are set based on a value table, and can correspondingly be switched back from the controlled operation into the regulated operation. Thus it is possible, for example, during a thermal expansion to regulate the preload to the greatest possible extent, or completely, based on a predetermined preload pressure and during a subsequent thermal contraction, such as, for example, rapid quenching, to increase the preload pressure to a fixed value.

Here the value table, or a setting of the clamping force, contact force, and/or friction force based on values of the value table, can depend in particular on measured and/or calculated temperature changes that are to be anticipated in the workpiece during the processing procedure.

According to a further advantageous exemplary embodiment, at least one of the clamping units is formed as an eccentrically supported clamping cylinder or slide shoe. The clamping cylinder and/or slide shoe can themselves be formed as movable or rotatable elements. However, alternatively or additionally it is also possible that they each include at least one further movable element. Furthermore, ribbings, or coatings made of, for example, friction particles, can advantageously be applied to the clamping cylinder; the ribbings or coatings facilitate the contact with the workpiece and ensure a movement/drive of the workpiece in the workpiece holding device.

According to a further preferred exemplary embodiment, the workpiece holding device furthermore includes at least two, preferably at least three, support units that are designed to support the workpiece. Here it is preferred in particular when the support unit includes a rotatable support element, for example, a rotatable sleeve on which the workpiece is supported and that rotates with the workpiece during movement of the workpiece. It can thereby be ensured on the one hand that the workpiece is supported in a tilt-free manner and on the other that the workpiece is movable easily and in a low-friction manner. Furthermore, one or more of the support units can also be formed as a drive unit.

Alternatively or additionally, at least one of the support units can also be designed as a drive unit. Here too, it is particularly preferred when the rotatable support element of the support unit is actively rotationally driven in a manner analogous to the above-described rotatable clamping element of the clamping unit. Also in this case, the rotatable support element can be formed as friction wheel or friction roller that abuts against the workpiece. It is also possible that the rotatable support element only includes a friction surfacing or a friction coating that provides the active drive.

Furthermore, as already indicated above, an exemplary embodiment is preferred in which the rotatable element of the at least one clamping unit and/or support unit configured as a drive unit is actively driven, wherein the at least one rotatable element of the clamping unit and/or support unit not configured as drive unit is respectively set into rotation passively by the movement of the workpiece. This makes possible a particularly low-friction and energy-saving movement of the workpiece.

According to a further preferred exemplary embodiment, at least one rotational speed measuring unit is furthermore provided that determines a rotational speed of the drive unit and in which a further rotational speed measuring unit is provided on one of the passive rotating elements; the rotational speed measuring unit determines a rotational speed of the passively driven clamping units and/or support units. In addition to the abovementioned contact force determination, the rotational speed measurement can also be used to determine whether there is sufficient frictional force/contact force of the drive unit, or whether the clamping force applied by the clamping units is sufficient to secure the workpiece sufficiently firmly in the workpiece holder. Thus, for example, the controller can be designed to control the drive unit and/or the clamping unit and/or the support unit in order to optimize the contact force or the clamping force and to minimize the slippage.

In particular, it is advantageous when the controller is furthermore designed to increase a contact force of the friction roller/friction wheel and/or a clamping force of the clamping units when a predetermined rotational speed difference is exceeded and/or to issue a notification about an increased slippage.

The clamping units, support units, and/or drive units of the workpiece holding device can be individually or jointly controllable.

In order that the clamping units, support units, and/or drive units do not themselves experience too large a thermal expansion/contraction, they are advantageously made from a temperature-resistant material, such as, for example, ceramic, polymer ceramic, aluminum silicate, stone, fireclay or from special steel alloys.

A further aspect of the present invention relates to a method for the thermal treatment of a workpiece that is received in a workpiece holding device as described above, in which the method includes the following steps:
inserting the workpiece into the workpiece holding device;
synchronously clamping all clamping units until each clamping unit contacts the workpiece and abuts against the workpiece with a predeterminable, equally high, clamping force;
activating the drive unit for the moving of the workpiece in the workpiece holding device;
starting the thermal treatment;
actively or passively readjusting the clamping units and/or drive unit during the thermal treatment so that a predetermined clamping force, friction force, and/or contact force is applied between clamping unit and/or drive unit during predeterminable time periods or the entire thermal treatment.

Deformations during the thermal treatment of the workpiece can thereby be avoided.

Further advantages and advantageous embodiments are specified in the description, the drawings, and the claims. Here in particular the combinations of features specified in the description and in the drawings are purely exemplary so that the features can also be present individually or combined in other ways.

In the following the invention is described in more detail using the exemplary embodiments depicted in the drawings. Here the exemplary embodiments and the combinations shown in the exemplary embodiments are purely exemplary and are not intended to define the scope of the invention. This scope is defined solely by the pending claims.

### BRIEF DESCRIPTION OF THE DRAWINGS

FIG. 1 is a schematic depiction of an induction hardening system including a workpiece holding device according to a preferred exemplary embodiment of the present disclosure.

FIGS. 2a and 2b are schematic depictions of a first preferred exemplary embodiment of a workpiece holding device with a synchronous clamping unit according to the present disclosure.

FIG. 3 is a schematic depiction of a further preferred exemplary embodiment of a workpiece holding device with a synchronous clamping unit according to the present disclosure.

FIG. 4 is a schematic depiction of a further preferred exemplary embodiment of a workpiece holding device with a synchronous clamping unit according to the present disclosure.

FIG. 5 is a schematic depiction of a further preferred exemplary embodiment of a workpiece holding device with a synchronous clamping unit according to the present disclosure.

FIG. 6 is a schematic depiction of a further preferred exemplary embodiment of a workpiece holding device with a synchronous clamping unit according to the present disclosure.

FIG. 7 is a schematic depiction of a further preferred exemplary embodiment of a workpiece holding device with a synchronous clamping unit according to the present disclosure.

FIG. 8 is a schematic depiction of a further preferred exemplary embodiment of a workpiece holding device with a synchronous clamping unit according to the present disclosure.

### DETAILED DESCRIPTION

In the following, identical or functionally equivalent elements are designated by the same reference numbers.

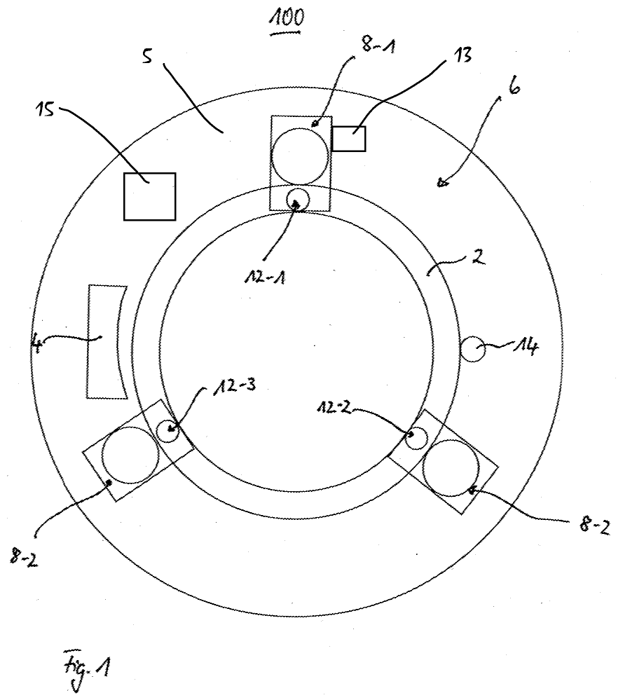

FIG. 1 schematically shows a plan view of an induction hardening system 100 that is designed to inductively harden a workpiece 2, e.g., a bearing ring, with the aid of an inductor 4. Here the induction hardening system 100 depicted in FIG. 1 is formed as a hardening system in which the inductor 4 always heats only one part of the workpiece 2 while the workpiece 2 is moved past the inductor 4. For this purpose the workpiece 2 is clamped into a main body portion 5 of a workpiece holding device 6 and moved past the inductor 4. For this purpose, the workpiece holding device 6 has clamping units 8-1, 8-2, 8-3 for holding the workpiece 2, which are designed to hold the workpiece 2.

Furthermore, FIG. 1 shows that in the exemplary embodiments depicted, the workpiece 2 is supported by three support units 12-1, 12-2, 12-3.

Now instead of, as in the prior art, rotating the entire system 6 in order to move the workpiece 2 along the inductor 4, a drive unit 14 is now furthermore provided that is designed to rotate only the workpiece 2. Of course, more than one drive unit 14 can also be present.

Here the drive unit 14 can be, for example, a friction wheel or a friction roller that acts directly on the workpiece 2 and sets it in rotation. Instead of a separate drive device 14 as depicted in FIG. 1, one of the clamping units 8 and/or of the support units 12 can also be configured as a drive unit 14. Thus, for example, the clamping unit 8-1 can be configured simultaneously as a friction wheel or a friction roller that in turn acts directly on the workpiece 2 and sets it in rotation.

The clamping units 8, the support units 12, and/or the drive unit 14 can be moved radially, axially, and/or tangentially in order to optimally abut against the workpiece 2. Furthermore, it is possible to attach one or more measuring devices 13 on one or more of the units 8, 12, 14 that are designed to measure a contact force and/or clamping force and/or friction force between the clamping units 8 and/or the support units 12 and/or the drive unit 14 and the workpiece 2. Furthermore, a controller 15 can also be provided that interacts with the units 8, 12 and 14 such that the units 8, 12, 14 interact with the workpiece 2 with a predetermined contact force, clamping force, and/or friction force.

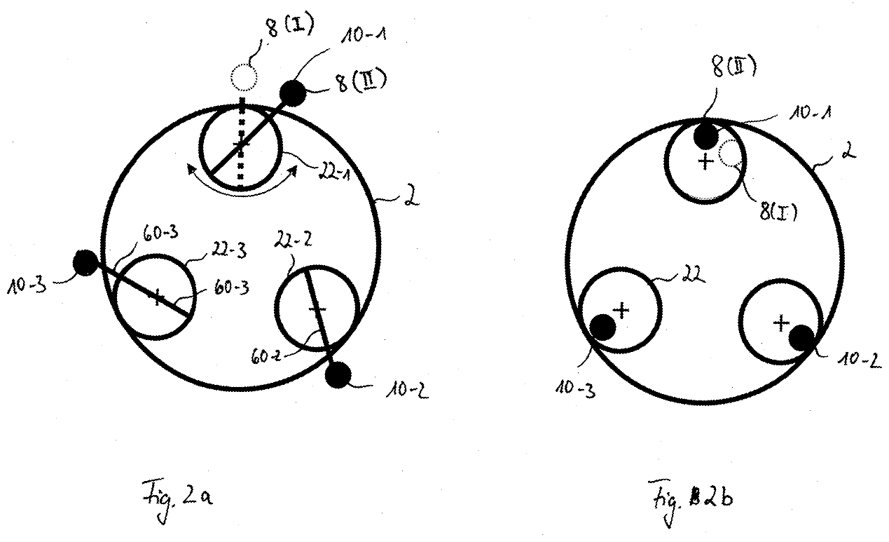

As the following exemplary embodiments of FIGS. 2 to 8 show, the clamping units 8 themselves are synchronously clamped with the aid of an adjusting device 20 in order to apply a substantially equal radial, axial, and/or tangential clamping force onto the clamping units 8.

As depicted in particular schematically in FIGS. 2a and 2b, with the aid of the adjusting device 20, the clamping units 8 are brought from an open position 8(I) (dashed) into a closed position 8(II), wherein in the closed position 8(II) the clamping units abut against the workpiece with a certain clamping force. In the exemplary embodiments depicted in the Figures, the transition from an open position 8(I) into a closed position 8(II) is effected by a rotational movement of the clamping units 8.

For this purpose, as schematically indicated in FIGS. 2a and 2b, the clamping units 8 can include, for example, rotary discs 22 on which eccentric clamping cylinders 10 are supported that in turn come into contact with the workpiece 2. Alternatively, of course, the clamping unit 8 itself, for example, the clamping cylinder 10, can also be elliptical so that a corresponding rotational movement leads to the application of a clamping force to the workpiece 2.

Furthermore, FIG. 2a shows that a carrier 60 is attached to each rotary disc 22; the carriers 60 are offset with respect to a center point M of the workpiece holding device 6, and the clamping elements 10 are attached to the carriers 60. The carriers 60 are pivoted by a movement of the rotary disc 22 so that the clamping elements 10 directly contact the workpiece 2 (closed position) or are spaced from it (open position). Here the adjusting device 20 ensures that the rotational movement of the rotary disc 22 is effected simultaneously and synchronously.

Alternatively and, as depicted in FIG. 2b, the clamping cylinders 10 can be supported eccentrically on rotary discs 22 so that a movement of the rotary discs 22 leads to a local displacement of the clamping cylinders 10.

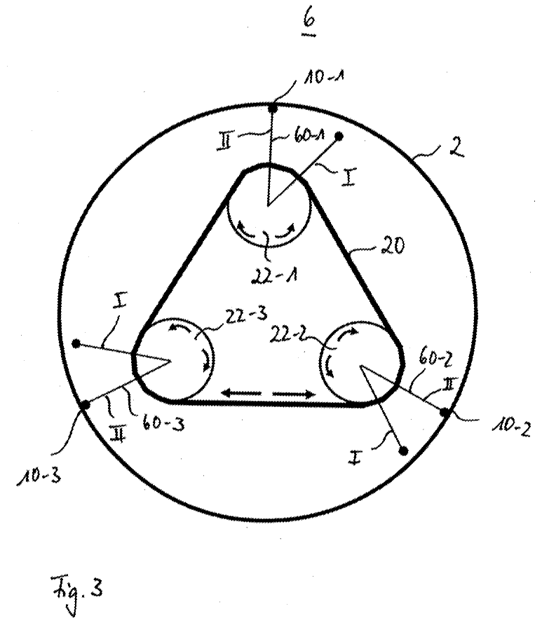

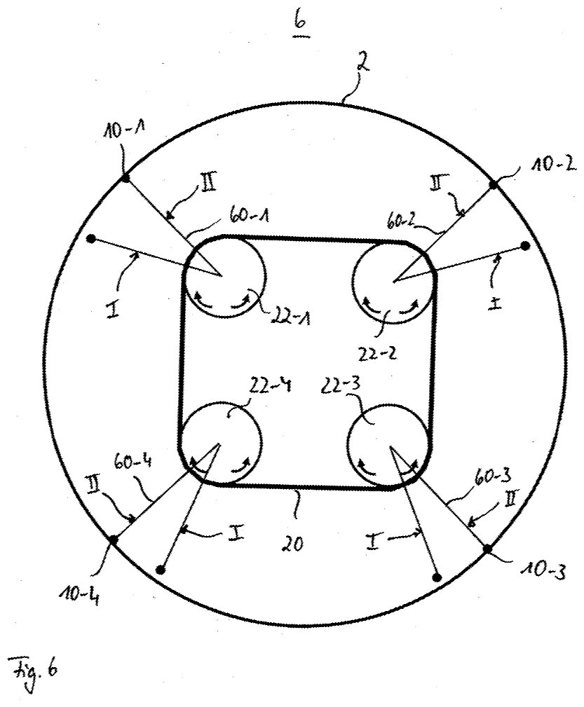

FIGS. 3 to 8 show further different examples, wherein in FIGS. 3 to 5 three clamping units 8-1, 8-2, and 8-3 are synchronously clamped while in FIGS. 6 to 8 four clamping units 8-1, 8-2, 8-3 and 8-4 four are synchronously clamped.

Here, the figures each show various embodiments of how, for example, such rotary disks 22 or, in general, the clamping units 8, can be rotated in order to synchronously exert a clamping force on the workpiece. A carrier 60 is attached to each of the rotary discs 22; the carriers 60 are disposed offset with respect to a center point M of the workpiece holding device 6, and the clamping elements 10 are attached to them. As also depicted in FIGS. 2a and 2b, the carriers 60 are pivoted by a movement of the rotary disc 22 so that the clamping elements 10 directly contact the workpiece 2 (closed position) or are spaced from it (open position). Here the adjusting device 20 ensures that the rotational movement of the rotary disc 22 is effected simultaneously and synchronously.

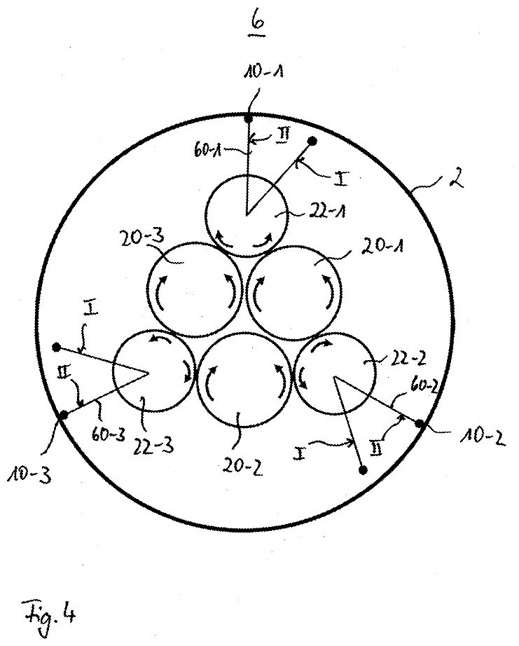

FIGS. 3 and 6 each show exemplary embodiments in which three clamping units 8-1, 8-2, 8-3, (FIG. 3) or four clamping units 8-1, 8-2, 8-3 and 8-4, (FIG. 4) are synchronously movable by the adjusting device 20, which in the exemplary embodiment depicted is represented by a chain or a belt 20, from an open position I into a closed position II. The closed position II is represented by abutment of the clamping element 10-1, 1-10-3, or 10-4 against the workpiece 2, while in the open position the clamping elements 10-1, 1-10-3 or 10-4 are spaced from the workpiece 2. The mechanical coupling via the chain or the belt 20 has the advantage that all clamping units are rotated synchronously and simultaneously with an identical force and thus abut against the workpiece 2 with the same clamping force. No further control device is needed here since the chain or the belt directly rotates all clamping units.

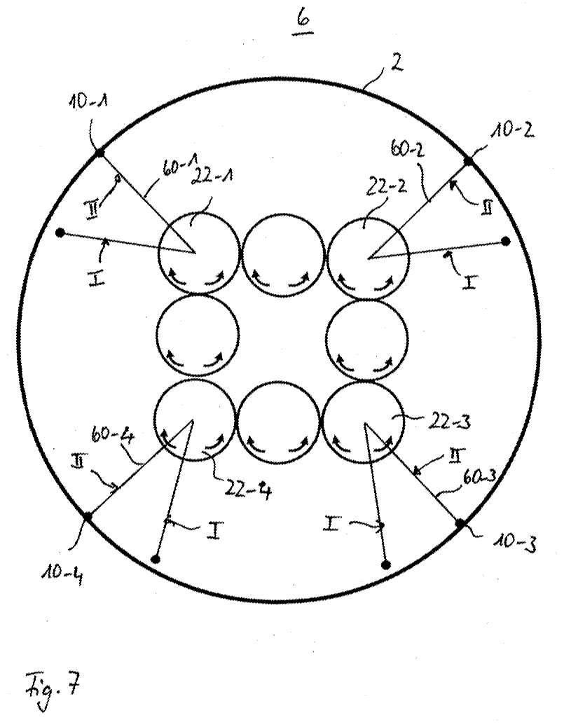

FIGS. 4 and 7 each show an exemplary embodiment for three or four clamping units in which the clamping units are rotated from an open position into a closed position via actuators 20-1, 20-2, and 20-3 or 20-4 disposed between them. The closed position II is represented by abutment of the clamping element 10-1, 1-10-3, or 10-4 against the workpiece 2, while in the open position the clamping elements 10-1, 1-10-3 or 10-4 are spaced from the workpiece 2. Here the actuators can be, for example, gears that interact with a gearing on the clamping unit 8 or the rotary disc 22. Here the intermediate actuators 20-1 to 20-3 (FIG. 4) or intermediate actuators 20-1-20-4 (FIG. 7) can each be driven separately or via a common central element (not depicted) in order to achieve the synchronous rotation and thus the synchronous application of the clamping force. Similarly, only one of the actuators 20-1 may also be rotated since the rotation acts on all elements simultaneously via the mechanical coupling between the elements 8 or 20. In the alternative, the actuators could be friction discs that fictionally engage one another and the rotary discs 22 without the use of gears.

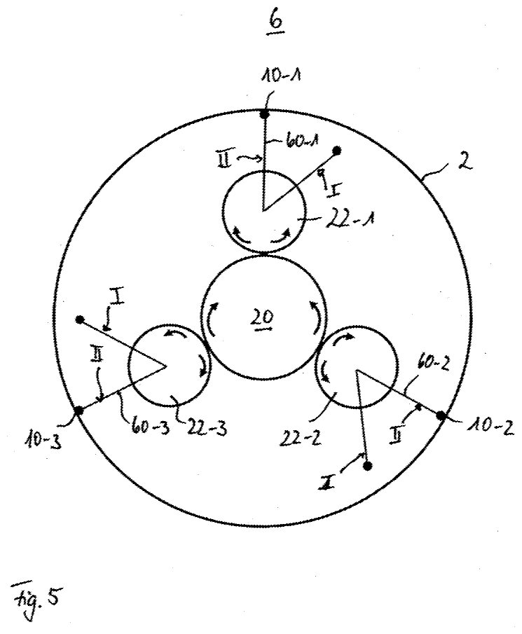

FIG. 5 shows an exemplary embodiment in which the clamping units 8-1, 8-2 and 8-3 are set in rotation by a centrally disposed adjusting device 20, for example, using a central gear 20 that meshes with corresponding gearings on the clamping device 8 or the rotary disc 22, in order to be brought from an open into a closed position. The closed position II is represented by abutment of the clamping element 10-1, 1-10-3, or 10-4 against the workpiece 2, while in the open position the clamping elements 10-1, 1-10-3 or 10-4 are spaced from the workpiece 2. Here, for example, the adjusting device can be configured as a central gear that engages in corresponding gears on the clamping units 8-1, 8-2 and 8-3, or in the alternative, as a friction disc that frictionally engages the rotary discs without the use of gears.

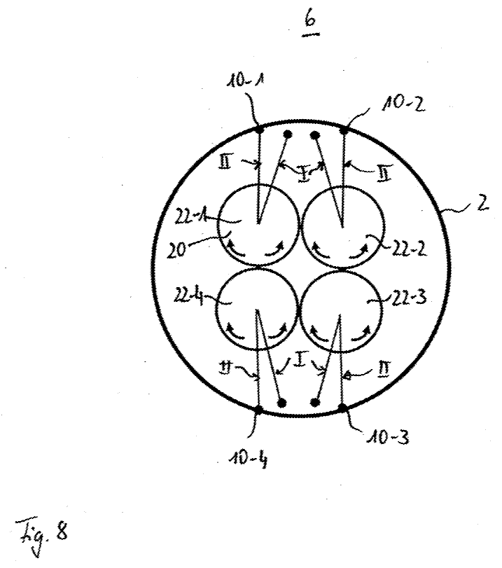

FIG. 8 shows an exemplary embodiment in which the adjusting device 20 is installed in one of the clamping units 8-1, 8-2, 8-3 or 8-4, in particular the rotary disc 22-1. Because the rotary discs 22-1-22-4 mesh with one another, the movement of one rotary disc 22-1 also induces the movement of the other rotary discs 22-2-22-4. It is thus sufficient that only one rotary disc functions as an adjusting device 20 which actively rotates the clamping unit from an open position into a closed position. Since the clamping units 8-1 to 8-4 are in engagement with one another as depicted in FIG. 8, the rotation of one clamping unit 8-1 is transmitted to the clamping unit 8-1, from there to the clamping unit 8-3, and there in turn to the clamping unit 8-4. The closed position II is represented by abutment of the clamping element 10-1, 1-10-3, or 10-4 against the workpiece 2, while in the open position the clamping element 10-1, 1-10-3 or 10-4 are spaced from the workpiece 2.

Even when a radially outwardly applied clamping force is shown in the Figures, it is clear to a person skilled in the art that a radially inwardly applied clamping force can also be generated with the same system, for example, by the clamping cylinders 10 simply being attached to longer carriers and abutting radially outwardly against the workpiece 2. Here the clamping itself can also be applied, for example, by the same system made of rotatable rotary discs that are synchronously rotated with the aid of an adjusting device. Thus with the same basic system made of an adjusting device and rotary disc, both a radially outwardly and a radially inwardly directed synchronous clamping force can be applied so that the workpiece holding device is flexibly usable for the widest variety of applications.

Overall, with the aid of the synchronous application of a clamping force, a space-saving and easy-to-operate system can be provided that allows a simple force regulation and position regulation. Such a system is also particularly robust, since a complicated electronic controlling of the individual clamping elements can be omitted, since this system applies a clamping force onto the workpiece simultaneously and uniformly via its mechanical coupling.

As used herein, a controller may be a programmable hardware component that can be formed by a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved workpiece holding device

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

100 Hardening system
2 Workpiece
4 Induction coil
5 Main body
6 Workpiece holding device
8 Clamping unit
10 Clamping element
12 Support unit
13 Measuring device
14 Drive unit
15 Controller
16 Support element
18 Friction roller
20 Adjusting device
22 Rotary disc
22 Radially outer side of the workpiece
24 Radially inner side of the workpiece
60 Carrier

What is claimed is:

1. A workpiece holding device for holding a workpiece in a heat treatment system while the workpiece undergoes a thermal expansion and/or contraction, the workpiece holding device comprising:
at least two clamping units configured to apply a radial and/or an axial clamping force to the workpiece to hold the workpiece in the workpiece holding device in a predefined position, and
adjusting means for setting the at least two clamping units to synchronously apply a substantially identical radial and/or axial clamping force to the workpiece.

2. The workpiece holding device according to claim 1,
wherein the adjusting means comprises a plurality of adjusting units, and
wherein a first one of the plurality of adjusting units is directly driven and all other ones of the plurality of adjusting units are driven by the first one of the adjusting units.

3. The workpiece holding device according to claim 2,
wherein the adjusting means includes a belt, a chain or a gear that mechanically couples the at least two clamping units.

4. The workpiece holding device according to claim 3, wherein the at least two clamping units comprises exactly three clamping units or exactly four clamping units.

5. The workpiece holding device according to claim 3,
wherein the at least one clamping unit includes at least one clamping cylinder that is preloaded against the workpiece with a predetermined abutment force, and
wherein clamping element is furthermore configured to move to maintain the predetermined abutment force during the thermal expansion and/or contraction of the workpiece.

6. The workpiece holding device according to claim 5, wherein the at least one clamping cylinder is rotatable about an axis parallel to a rotational axis of the workpiece.

7. The workpiece holding device according to claim 6,
including a drivable friction wheel or a drivable friction roller configured to frictionally engage the workpiece to rotate the workpiece.

8. The workpiece holding device according to claim 7, wherein a contact force between the drivable friction wheel and the workpiece or the drivable friction roller and the workpiece is adjustable.

9. The workpiece holding device according to claim 6,
wherein a first one of the at least one of the clamping cylinder is actively rotationally driven.

10. The workpiece holding device according to claim 5,
including a controller configured to control the clamping force.

11. The workpiece holding device according to claim 5,
a force sensor configured to measure the clamping force and to send a signal indicative of the clamping force to the controller.

12. The workpiece holding device according to claim 11,
including at least three support rotatable support cylinders configured to support the workpiece.

13. A method comprising:
providing a workpiece holding device according to claim 1,
inserting the workpiece in the workpiece holding device,
using the adjusting means to synchronously clamp the at least two clamping units against the workpiece with a predetermined and equal clamping force,
rotating the workpiece relative to the workpiece holding device,
performing a thermal treatment on at least a portion of the workpiece in the workpiece holding device, and
while performing the thermal treatment, adjusting the at least two clamping units to maintain the predetermined clamping force.

14. The workpiece holding device according to claim 1,
wherein the at least two clamping units each includes a rotatable disk, and
wherein the adjusting means comprises a chain or belt operatively connected to each rotatable disk to cause the rotatable disks to rotate simultaneously.

15. The workpiece holding device according to claim 1,
wherein the at least two clamping units each includes a rotatable disk, and
wherein the adjusting means comprises a gear operatively connected to each rotatable disk to cause the rotatable disks to rotate simultaneously.
